(19) United States
(12) Patent Application Publication
(10) Pub. No.: US 2003/0037001 A1
(43) Pub. Date: Feb. 20, 2003

(54) E- commerce account holder security participation

(76) Inventor: Diane A. Richardson, Bridgeport, CT (US)

Correspondence Address: Michael S. Neustel, Suite No. 4, 2534 South University Drive, Fargo, ND, 58103, US

(21) Appl. No.: 09/923,668

(22) Filed: Aug. 6, 2001

(51) Int. Cl. G06F 17/60

(52) U.S. Cl. 705/44; 705/42

(57) ABSTRACT

E-commerce account holder security participation is provided for preventing unauthorized access to and use of private electronic account information. A method is provided to enable the average e-commerce account holder to participate in the protection of their private accounts and information. The account holder specifies and controls a single or a series of access parameters, associated with each private account or record, that must be satisfied before a transaction of funds or information is authorized. This account access protection is provided in addition to connection security provided in e-commerce transactions and is structured to stop unauthorized user access in possession of the account holder's name, address, account number or credit card number. The account holder can effect access parameter changes anywhere at any time via a computing device where the access parameter data is stored in the computing device, secure server or other secure location. The parameters for each card or account may include one or any combination of a) password known only to the Web user and credit/information institution, b) which account in the account holder's name is authorized for activity c) when the account is available, d) how each account is to be used, e) where each account is to be used and f) the maximum monetary amount for a single or a specified number of transactions.

### BACKGROUND OF THE INVENTION

1. Field of the Invention

The invention generally relates to e-commerce account access methods for electronic payment and information systems and more particularly an additional safeguard under account holder control to prevent unauthorized access to private electronic account information.

With the proliferation of connections to the Internet by a rapidly growing number of individuals, the viability of the Internet as a widely accepted medium of communication and business activity has increased correspondingly. The Internet is comprised of a global computer network allowing various types of data to be transmitted including but not limited to video, audio and graphical images. The type of connection the individual has to the Internet determines the overall quality and speed of their Internet experience. With increasing bandwidth and decreasing prices of Internet connections available to consumers such as DSL, ISDN, T1, T3 and cable modems, increased usage and quality of Internet related activities will inevitably occur.

2. Description of the Prior Art

Electronic commerce has become high volume shopping and business transactions over the Internet's Web. Even though e-mail, File Transfer Protocol (FTP), Telnet and browsing are the most widely used Internet/intranet applications, e-commerce is the fastest growing application. Due to the growing popularity of the Internet, an increasing number of product and service providers have set up shop on the Web to take advantage of the global marketplace. More businesses are also engaged in electronic commerce with each other, expected to reach $1.5 trillion by 2004, up from an estimated $114 billion in 1999.

Today, many forms of business are available to the Web browser. For example, the user can browse through a company's catalog, look at the price lists, place a credit card order and check an order status 24 hours a day, 7 days a week, 365 days a year. Via the Internet, bank customers can monitor account balances, transfer money from their savings account to their checking account, pay bills electronically, apply for loans and pre-qualify for mortgages. There are hundreds of personal finance products from personal finance software companies and banking products from banks and other financial institutions to provide online access to brick and mortar (a physical building) or virtual financial institutions. The authorized user can also enroll and check benefits with healthcare organizations, review sensitive employment records or communicate sensitive business information.

With online shopping, banking and information services, Web browsers and service providers (client/servers) require a method to move data securely across a public environment, such as the Web, to combat the security attack known as identity theft. Identity theft occurs when an unauthorized user has acquired private user or client information such as financial account numbers, credit card numbers, health, property or proprietary business information, passwords and the like and uses the information for fraudulent purposes such as credit card fraud or spoofing (fraudulent user pretends to be someone else so as to fake otherwise legitimate Web sites and e-mail messages).

FIG. 1 shows a simplified representation 100 of the well known Wide Area Network (WAN) 101 client/server communications where a client, the workstation or personal computer (PC) 102 or as one of many alternatives, a personal digital assistant (PDA) 104 via the wireless system 103 communicates with a Web server of a store 107 or bank 106 via a public wide area network such as an Intranet or Internet. Teller Machine (ATM) 105 is a special purpose client that accepts private data to access financial records, transfer funds or dispense cash. The workstation PC could take the form of the personal computer deployed at home or within a business as an individual workstation or as part of a local area network (LAN) but with access to the WAN. The store and bank of FIG. 1 are physically realized as proprietary applications resident on a Web server that represents bricks and mortar or virtual establishments offering goods and services to the Web browser.

With respect to the Internet, a Web browser communicates with the Web server using the Transmission Control Protocol/Internet Protocol (TCP/IP). For the majority of Internet communications, a Web browser communicates with a Web server using a TCP/IP service application known as Hyper Text Transfer Protocol (HTTP). Another Web graphical service application called Secure HTTP (S-HTTP) is HTTP with security enhancements that address the issue of moving data securely across the Internet. S-HTTP uses the Secure Socket Layer (SSL) to protect the information. SSL is a transaction layer protocol that is not tied to a particular application and can by layered on any application or protocol such as HTTP (hence S-HTTP), FTP or other Internet service applications. SSL sits on top of TCP/IP taking care of encryption, security keys, authenticating the server and with version SSL 3.0, authenticating the client as well as the server through an exchange of digital certificates before the application sends or receives any data. SSL was issued as U.S. Pat. No. 5,657,390 Aug. 12, 1997 to Elgamal et al., assigned and owned by Netscape Communications Corporation and titled “SECURE SOCKET LAYER APPLICATION PROGRAM APPARATUS AND METHOD”. S-HTTP information and demonstrations are available at www.commerce.net and the S-HTTP specification is available under /pub/standards/drafts/shttp.txt from ftp.commerce.net.

SSL, as well as other secure transaction protocols such as Transport Layer Security (TLS) and Secure Electronic Transaction (SET), use an exchange of digital certificates between client and server to act as proof of identity prior to any transaction. During set-up of a secure transaction, the server identifies itself with a certificate issued by a trusted authority (CA). The server may or may not request that the client transmit a certificate to the server for authentication purposes depending on the service application and version of secure transaction protocol known to both the client and server.

A widely accepted international standard for digital certificates is defined in the ISO authentication framework X.509 (http://www.rsa.com/rsalabs/newfaq/q 165.html). This standard requires all certificates to contain a version number, a serial number, an algorithm identifier, the name of the issuer, the validity period, the subject or distinguished name, the subject public key, an issuer unique identifier, a subject unique identifier, an extension field and the CA's signature. The X.509 standard is supported by transaction layer security protocols such as SSL.

The CA is a trusted entity willing to vouch for the identities of those to whom it issues certificates. The CA may include a company that issues certificates to the employees, a professional body that issues certificates to its members or a country that issues to its citizens. Exemplary commercial CAs include Verisign (http://www.verisign.com) and GTE CyberTrust (http://www.cybertrust.gte.com).

The following are the steps of how the Web client and server set-up through SSL:

the Web browser indicates a secure transmission with the https://protocol;

the server program sends its digital certificate to the client program;

the client program checks to see if the certificate has been issued by a trusted authority (CA);

the client program compares the information in the digital certificate with the authentication key;

the client program tells the server what encryption algorithms it can understand;

the server program chooses the strongest encryption algorithms that it has in common with the client program and tells the client what encryption algorithm to mutually use to communicate;

the client program encrypts the key and sends it to the server program;

the server program receives the encrypted key from the client and decodes it;

the client and server programs use the key throughout the subsequent client/ server transaction.

The steps above are typical of a method for the Web browser and Web site to prepare a “secure place” for a subsequent secure transaction to occur. Typically, the Web user would now enter the private client information including name, address and a credit card number for verification by a credit card authorization service (CCAS) 108. Upon a match of the entered client information with the records in the CCAS, the transaction or credit card purchase is enacted.

There are two basic security deficiencies in the existing transaction methods. First, virtually anyone, from any connected computer, at any time and in possession of the (stolen) private client information, could gain access to private accounts or other sensitive information. Current protocols, as highlighted above, do not authenticate the actual physical client, but only compare the database account information with the entered private client information. The secure transaction protocols are only concerned with the security of the connection, and where the client digital certificate is not exchanged, not the actual operating user. Versions of the secure transaction protocols that include an exchange of the client digital certificate only authenticate the computing machine that holds the certificate, and like the Web server, not the actual physical user. Second, security software that is linked to secure transaction protocols can only provide a limited measure of protection since the Web client must trust someone in the network. Like trusting the person that accepts a credit card over the telephone or at a store desk, the Web client must trust the server administrator, a person with access at the physical Web site, with credit card information since the server administrator maintains the security software, the physical security of the computers and the security of passwords and private keys.

What is needed to correct these security deficiencies in the existing application/ secure transaction protocol methods is an additional account access step defined and controlled by the account holder to protect the accounts against unauthorized access even when an unauthorized user attempts access with stolen private client information or attempts to use unauthorized accounts opened in the client's name.

In these respects, the e-commerce account holder security participation according to the present invention substantially departs from the conventional concepts and designs of the prior art, and in so doing provides a system primarily developed for the purpose of preventing unauthorized access to private electronic account information.

### SUMMARY OF THE INVENTION

In view of the foregoing disadvantages inherent in the known types of prior art now present in the prior art, the present invention provides a new e-commerce account holder security participation wherein the same can be utilized for preventing unauthorized access to private electronic account information or the use of unauthorized accounts opened in the client's name.

The general purpose of the present invention, which will be described subsequently in greater detail, is to provide a new e-commerce account holder security participation that has many of the advantages of the prior art mentioned heretofore and many novel features that result in a new e-commerce account holder security participation which is not anticipated, rendered obvious, suggested, or even implied by any of the prior art, either alone or in any combination thereof.

The present invention relates to an account access protection method to provide an account holder with access control over personal accounts and sensitive information to guard against electronic commerce based credit card fraud and account/record theft. The method includes storing client defined access parameters, establishing a connection via a secure transaction protocol, entering requested private client information, comparing entered private client information and gathered data with client defined access parameters and determining to authorize or deny the transaction based on a match between gathered data and the access information with the entered requested private client information.

The access parameters entered and controlled by the client are comprised of one or a combination of the following: a password; a list of client accounts with account identity selected to enable or deny a transaction; a list of selected merchants selectively enabled or denied for transaction with the client accounts; a list comprising of location codes, such as Post Office zip codes and telephone area codes selectively associated with a client account and selected merchants and a selection to enable or deny access to the client accounts transacted through a bricks and mortar (i.e. bank or merchant) establishment or a network connection.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary objective of the present invention is to provide an e-commerce account holder security participation that will overcome the shortcomings of the prior art systems however employed.

A second objective is to provide an e-commerce account holder security participation for preventing unauthorized access to private electronic account information.

A third objective is to provide an e-commerce account holder security participation for preventing the use of unauthorized accounts opened or created in the account holder's name.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a prior art diagram of an exemplary Internet structure with respect to the application of the invention.

FIG. 2 shows a diagram of the exemplary Internet structure with an embodiment of the invention.

FIG. 3 shows a flow diagram of the inventive process.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

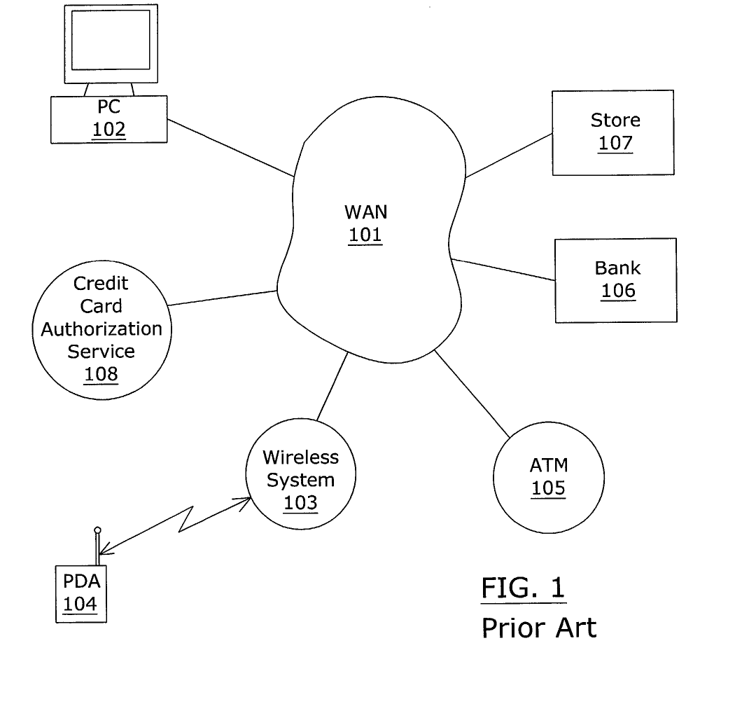

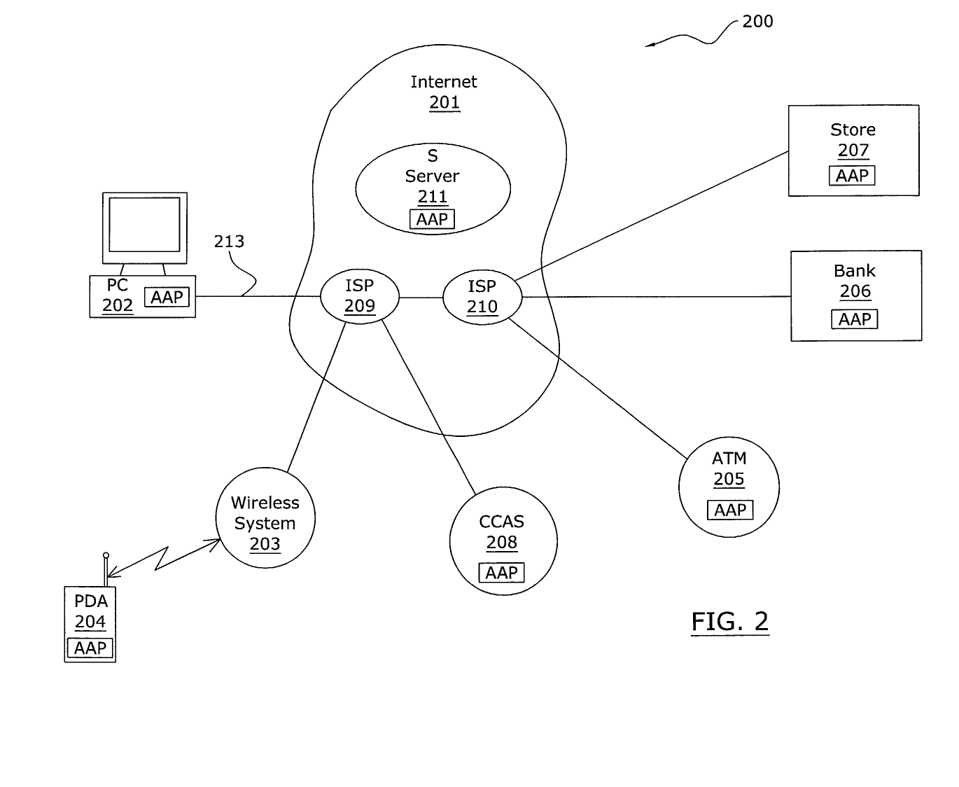

FIG. 2 shows the preferred embodiment 200 of the inventive concept in relationship to the Internet 201 as described for FIG. 1. The personal computer (PC) 202 and personal digital assistant 204 are shown to represent two examples of any device capable of providing a data processing capability equipped with a user interface and connection to an information network. As a detailed example, the PC includes a Pentium processor running at 120 MHz or faster, 16 Mb RAM, a multifunction network interface card (NIC) with 56 kbps FAX/Modem and 10Base-T Ethernet adapter (10 Mbps), a CD-ROM drive at double-speed (2×) or faster, sufficient ROM and hard drive for data handling and storage, serial and parallel ports, monitor, keyboard, mouse and loaded with the client application software. The client application includes browser software such as Microsoft's Internet Explorer or Netscape Navigator running under Windows 2000, Windows NT or the equivalent operating system to provide the end user interface and protocol compatibility across any well known digital link 213 to the Internet Service Provider 209 & 210.

FIG. 2 shows an embodiment of the inventive client application realized as a main application (supervisory computer program), termed Account Access Protection (AAP), resident as a computer readable medium on all clients, PC 202, PDA 204 via wireless system 203 and an ATM 205 and servers, secure server 211, store 207, bank 206 and credit card authorization facility (CCAS) 208. The ISPs are shown to illustrate basic connectivity across the Internet as is well known in the art. AAP is a supervisory set of logic functions that can be programmed to permit or deny a request for the use of each account based on the information exchanged between the client and server. AAP comprises the necessary additional account access “questions” to eliminate unauthorized access to private accounts and transactions of unauthorized accounts.

Under current e-commerce identity systems, it is extremely easy for an unauthorized user to open a billing account with the e-commerce merchant with only a few basic bits of stolen client information. The invention uses a main application to introduce an additional security measure under the account holders control to eliminate fraudulent access to private accounts and information and transactions of unauthorized accounts.

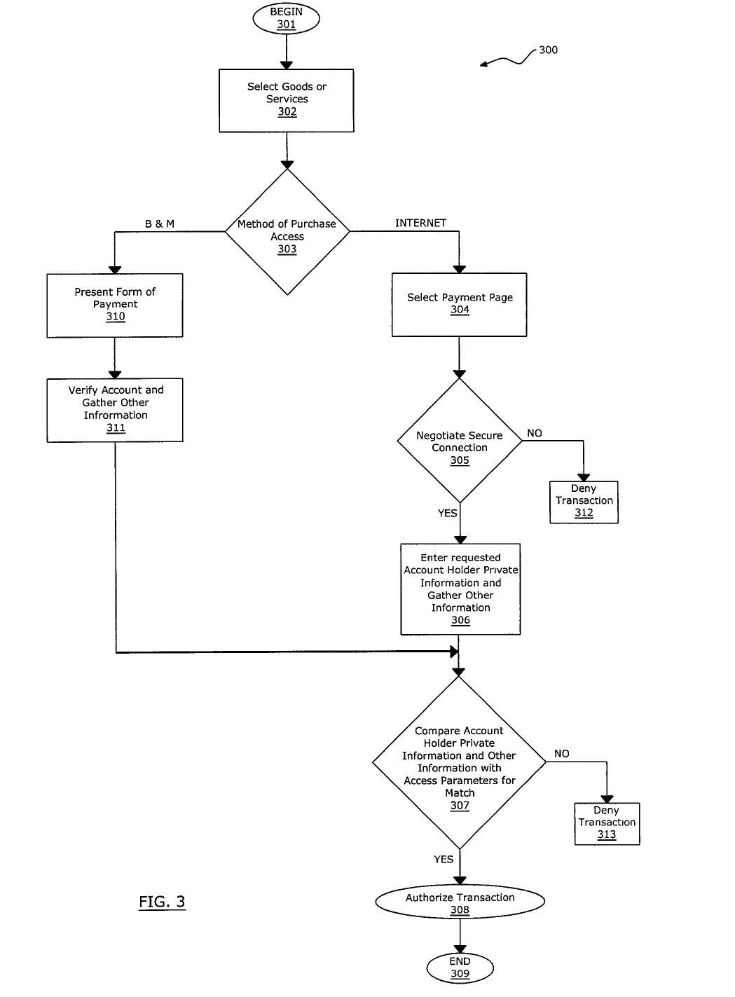

FIG. 3 is a flow diagram of the first embodiment 300 to implement the additional account access protection. The process begins 301 with the client or fraudulent party selecting goods and or services 302 using a B&M (Bricks and Mortar) establishment or online the Internet. These goods, in the case of the typical Internet “shopping” scenario 303, are placed in a cart to organize for purchase. The Web browser signals the client/server system of a readiness to purchase the goods through selecting the payment page 304 on the Web site. The Web site browser then negotiates a “secure place” with the Web site 305 prior to the transaction (the actual purchase) by selecting the alternative secure transaction application protocol. Web browsers, such as the popular Netscape Navigator, Windows Internet Explorer or Lotus Notes exchange the current Hypertext Transfer Protocol (HTTP) for Secure-HTTP layered on a secure transaction protocol such as Secure Sockets Layer (SSL) to provide the encryption and authentication of the client/server connection to effect the transaction. The exchange of client/server digital certificates during the set-up of the “secure” connection serves as authentication of the parties in the connection, computer to computer, but does not identify the actual physical user particularly when the version of the secure transaction protocol does not require the client to exchange a certificate. The user will typically receive a message whether or not to continue the transaction without a secure connection if the secure connection negotiation fails 312. If the secure negotiation is successful, the user is prompted to enter the account holder private information which usually includes account holder name, address and credit card or account number 306 while the AAP directs the user session origination source to gather other information. The Web site, through a credit card authorization system, then compares the entered private client information (some of which is perhaps stolen) with other gathered information and the client defined access parameters 306 to determine authorization to proceed with the transaction (purchase) 307. Other gathered information may include the time, date and physical location in terms of a Post Office zip code, telephone area code, country code or positional coordinates at the point of the origination of the requested transaction. If there is a match between the entered client private information and other gathered information with the access parameters, the transaction is authorized 308 otherwise, it is denied 313. The process ends with conclusion of the transaction 309.

The process for a B & M purchase is similar to an Internet purchase as shown in FIG. 3. The user physically presents a credit card, debit card, personal check or some other account bearing form of payment 310 with the merchant's entry of the account information. Next, the B&M establishment uses an authorization service while the AAP directs means to gather other variable information 311. At step 307, as for the Internet purchase, the AAP compares the entered private information (some of which is perhaps stolen) with other gathered information and the client defined Access Parameters to determine authorization to proceed with the transaction.

In the first embodiment Internet or B & M transaction, the account holder or client has stored the access parameters on the computing device under the personal control of the client to allow the client to effect changes to the access parameters as desired. The user's Web browser would also contain the additional supervisory main application with a means to access the access parameters. Client access would typically be provided as a table or any other suitable form by the Web browser located under a tool bar tab in the usual manner known to one skilled in the art. In the first embodiment, the account holder has pre-stored the selected access parameters under the AAP main application in a secure place such as a secure Web server for access during the request for transaction.

The table presented to the client via the client's computing device may take on a graphical appearance. The table may present both the B & M and Internet merchants on separate tables or together for visual and manipulation convenience as follows:

| | | | |
|---|---|---|---|
| Access | On | Off | Option |
| B&M | X | | |
| Internet | | X | USA |

| Account | | On | Off | Zip Code | On | Off | Area Code |
|---|---|---|---|---|---|---|---|
| Bank | A | | X | 06854 | | X | 203 |
| Citibank Visa | B | X | | 10043 | X | | 212 |
| American Express | C | | X | 10285 | | X | 212 |
| Wells Fargo | D | | X | 16606 | | X | 402 |
| MasterCard | | | | | | | |
| Merchant | | | | | | | |
| Super Market | E | X | | 06430 | X | | 203 |
| Texaco | F | X | | 06604 | X | | 203 |
| Sears | G | | X | 06604 | | X | 203 |
| Barnes & Noble | H | | X | 06604 | | X | 212 |
| E-Bay | I | | X | NA | | X | 408 |
| Amazon | J | | X | NA | | X | 206 |
| Other | Z | | X | 06430 | | X | 203 |

The user has selectively listed four accounts to be controllably associated to seven merchants and other location conditions. The first account entry “Bank” represents a debit card, checking account or other financial account with available funds. The table depicts which card or accounts are in the account holder's name, existing by virtue of the listing and the account holder's permission to be used, when each account is to be used, how each account is used and where each account can be used.

In the above example, the user has selected three choices: to use the Citibank Visa in the larger area code for shopping at the supermarket and for buying gas at Texaco and all transactions are to be conducted originating with brick and mortar establishments only, not the Internet (but where the Internet is used for verification and authorization). These choices are the access parameters to the client accounts that must be satisfied prior to completing any transaction. They are available to the client for review and change at any time. To effect the above selections, the PC equipped client would typically use a mouse or equivalent to point and click on the desired table grid or apply a pen press to the selected table grid as in application of a PDA, both approaches well known to those skilled in the art. Alternatively, the table grids for the selected account and merchant may exchange color, i.e. green to yellow, to indicate the current authorized transaction, green indicating off or safe and yellow indicating on or caution.

There are many advantages to each of the access parameters. A geographic boundary is a very important feature because many credit card numbers are being stolen in various ways and then used in other countries; therefore, all other transaction areas would be blocked if the account holder has specified use boundaries such as a Post Office zip code or the larger telephone area code as depicted in the above example. It would be a simple matter for the account holder to restrict access to a specific area when it is known that a particular account information or card has been lost or stolen in another place, a country and still retain use of the account. The safer policy would be to quickly turn the account off.

A similar policy to account control (protection) as in geographic restrictions would hold true for Internet use. The client needs only to pre-select the account and merchants for transactions over the Internet and enable the arrangement to coincide only with the time of the intended transaction. If the cardholder has set use for Internet Web sites with home addresses only in the United States, shown as USA in the tabularized example, the odds of unauthorized use outside the United States are greatly reduced.

The following table represents an example of the account holder's selected access parameters selected for activity over the Internet:

| | | | |
|---|---|---|---|
| Access | On | Off | Option |
| B&M | | X | |
| Internet | X | | USA |

| Account | | On | Off | Zip Code | On | Off | Area Code |
|---|---|---|---|---|---|---|---|
| Bank | A | | X | 06854 | | X | 203 |
| Citibank Visa | B | | X | 10043 | | X | 212 |
| American Express | C | | X | 10285 | | X | 212 |
| Wells Fargo | D | X | | 16606 | | X | 402 |
| MasterCard | | | | | | | |
| Merchant | | | | | | | |
| Super Market | E | | X | 06430 | | X | 203 |
| Texaco | F | | X | 06604 | | X | 203 |
| Sears | G | | X | 06604 | | X | 203 |
| Barnes & Noble | H | X | | 06604 | X | | 212 |
| E-Bay | I | X | | NA | X | | 408 |
| Amazon | J | | X | NA | | X | 206 |
| Other | Z | | X | 06430 | | X | 203 |

In the above example, transactions originating with bricks and mortar establishments are disabled whereas transactions originating with Internet Web sites in the USA are enabled. The user has selected to use a Wells Fargo MasterCard for shopping at Barnes & Noble and eBay on the Internet. Note that the transaction with some merchants such as Barnes and Noble may be authorized over the Internet or through a brick and mortar store since the company provides for either access, but only within the appropriate parameter sets.

Alternatively, the main application could include a transaction parameter to provide the client the ability to limit the total monetary value of a single or a specified number of specified transactions, applicable to either B & M or Internet access. The transaction tables previously shown could include, or a separate table or graphic page, the data entry fields to implement the monetary limit transaction parameter. To control the limit of a purchase made through a single payment or multiple payments, the additional table fields could typically include a) the total monetary limit value of the purchase (the not to exceed value) for a single or the sum of the payment or installments, b) the number of days between payments (30 days for monthly), c) the number of payments (a “1” would suffice for a single payment), and d) the payment amount. The main application would include appropriate program code to provide the client with user friendly data entry fields with the usual warnings of incorrect, missing or non applicable information by techniques well known to those in the art.

The advantages to the client to include a monetary limit value transaction parameter are manifold. For example, suppose the client wishes to purchase an item that is offered for sale at $29.95 plus $4.95 shipping and handling, for a transaction cost of $34.90, but a data error or a clerk enters $349.00 instead of $34.90. In this example, the AAP, properly enabled by the client, would deny the transaction. Another example, in the case of controlling the limit of a purchase with multiple payments, the user selects a purchase total of $104.70 to be paid in 3 monthly installments of $34.90. The client could prevent a demand for payment other than the payment agreed terms by specifying this transaction agreement under the AAP system.

Other transactions parameters such as a password or the time and date of the transaction may also be employed under the AAP system and presented to the client for in the manner describe above.

Generally, clients that want to utilize all the features of the Account Access Protection system would enable the accounts only during the period the user desires a transaction. The protection system could be pre-programmed to default all accounts to off after a transaction or period of time. The AAP system could also be encrypted or made code selectable to limit code copying.

The AAP system also provides enormous theft protection for the consumer that does not own a credit card since this service blocks all normal methods of using false accounts set-up in the user's name since the service can be used to turn off all types of potential transactions.

As an alternative, a PDA 204, Laptop computer, cellular phone or other wireless computing device would perform as an excellent portable means to access and change the user's access parameters. For access through portable wireless applications, it is preferred that the access parameters are stored in a secure place other than the wireless device such as a password protected client account on the secure server 211 administrating the main application.

In another embodiment, the main application would be configured to insure no one other than the account holder or other approved entity has access to a credit report and no report (good or bad) about a false user is ever entered. The main application would be configured to insure information through public record agencies is not accessed in a way that is not to the public good, or to the harm of the entity of record. For example, access to a driver's ID and records would be limited only to an authorized list of entities provided by the Department of Motor Vehicles (DMV) in a published off-site location, like a read only graphic based web site common to all accounts. The account holders' main program would use the Web site's secure transaction equivalent to permit only selected entities access.

In another embodiment, the main application would be configured to insure information about someone is not accessed in a way that is not to the public good, or the harm of the entity of record. Access to birth certificate or a marriage license would be limited only to authorized entities as in the above example.

In another embodiment, the main application would be configured to insure information about someone is not accessed in a way that violates the privacy of the individual. Access to social security or medical records would be limited only to a published list of authorized entities or by the ID method discussed above.

Establishing an independent information security method in conjunction with existing secure transaction protocols and methods is necessary to eliminate credit card fraud and information theft due to identity theft. The inventive account access protection method empowers the Web user for unique and independent control of their private accounts and information in addition to current connection security measures to stop unauthorized account access.

Having illustrated and described the principles of the invention in a preferred embodiment thereof, it should be readily apparent to those skilled in the art that the invention can be modified in arrangement and detail without departing from such principles.

The foregoing descriptions of embodiments of the invention have been presented for purposes of illustration and description only. They are not intended to be exhaustive or to limit the invention to the forms disclosed. For example, as in the use of ATM's to enter or change variable client information or permit or deny transactions. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. As to a further discussion of the manner of usage and operation of the present invention, the same should be apparent from the above description. Accordingly, no further discussion relating to the manner of usage and operation will be provided.

I claim:

1. A method of client account access protection for client/server or brick and mortar based transactions comprising:
storing client defined access parameters;
establishing a connection via a secure transaction protocol;
entering requested account holder private information;
comparing entered account holder private information and other gathered data with client defined access parameters; and
determining to authorize or deny the transaction;
changing client defined access parameters.

2. A method according to claim 1 where said client defined access parameters is any one or combination comprised of:
a password;
client accounts selected enabled or denied by the client for transaction;
merchants selected enabled or denied for transaction with client accounts by the client;
geographic location parameters selected for association with a client account and merchants by the client;
a monetary amount associated with each account and merchant to limit the total amount of a single or a selected number of subsequent transactions;
a selection by the client to enable or deny access to the client accounts transacted through a bricks and mortar establishment and/or a network connection.

3. A method according to claim 2 where said geographic location parameters comprise Post Office zip codes, telephone area codes and telephone country codes.

4. A method according to claim 2 where said network comprises the Internet or Intranet.

5. A method according to claim 1 where said storing client defined access parameters comprises storing the access parameters on a secure network server accessed by the client computing device.

6. A method according to claim 5 where the client computing device comprises a personal computer, a workstation, an Automatic Teller Machine and a personal digital assistant.

7. A method according to claim 1 where said establishing a connection comprises the SET, TLS or SSL secure transaction protocol.

8. A method according to claim 1 where said entering requested account holder private information comprises name, address, password, account number or credit card number.

9. A method according to claim 1 where said other gathered data comprises the location, date or time of said entering requested account holder private information for transaction.

10. A method according to claim 1 where said determining to authorize or deny the transaction comprises:
authorizing the transaction if requested private client information and other gathered data matches the said client defined access parameters; and
denying the transaction if the requested private client information and other gathered data does not match the said client defined access parameters.

11. A method according to claim 1 where said changing client defined access parameters comprises selectively changing the access parameters at any time by the client via the client computing device.
